(19) United States
(12) Patent Application Publication
(10) Pub. No.: US 2026/0154398 A1
(43) Pub. Date: Jun. 4, 2026

(54) REMOTE COMPUTATIONS USING TRUSTED EXECUTION ENVIRONMENTS

(71) Applicant: Texas A&M University System, College Station, TX (US)

(72) Inventor: Yongzhi Wang, Corpus Christi, TX (US)

(21) Appl. No.: 19/406,674

(22) Filed: Dec. 2, 2025

Related U.S. Application Data
(60) Provisional application No. 63/727,548, filed on Dec. 3, 2024.

(51) Int. Cl. G06F 21/53

(52) U.S. Cl. CPC G06F 21/53; G06F 2221/033

(57) ABSTRACT

To improve the ability of an application to process sensitive data, a trusted execution environment (TEE) can be used to store and compute sensitive sources (e.g., variables) from a set of sensitive sources. To make the TEE application language independent, a process can transform specific statements from the application code to a remote function call that can access the TEE. To identify these statements to transform, a forward and backward taint analysis can be performed to identify the statements to be transformed. The identified statements can be transformed into enclave instructions. At runtime, a cloak enclave environment within the TEE can execute the enclave instructions as called by the remote call in the application code. The sensitive sources in the identified statements are maintained and computed in the cloak enclave, grouped by a function runtime instance, which is uniquely identified by uuids.

### CROSS-REFERENCE

This application claims the benefit of U.S. Provisional Application Ser. No. 63/727,548, filed by Yongzhi Wang, on Dec. 3, 2024, entitled “REMOTE COMPUTATIONS USING TRUSTED EXECUTION ENVIRONMENTS,” commonly assigned with this application and incorporated herein by reference in its entirety.

### TECHNICAL FIELD

This application is directed, in general, to using enclave systems and, more specifically, to generating computations within the enclave system.

### BACKGROUND

As more users offload their computing tasks to the cloud, protecting sensitive data in those tasks becomes a necessary demand. Trusted Execution Environment (TEE) is a promising technology to realize this demand. TEE provides cloud a trusted area, which allows users to run code safely. These secure and isolated environments prevent unauthorized access or tampering of applications and data in use, thereby increasing the security assurance.

Examples of TEE implementation include Intel SGX, AMD SME, ARM TrustZone, and Intel TDX. Cloud vendors have offered various confidential computing services using different TEE technologies, including AWS Nitro Enclaves, Azure Confidential Computing, AliCloud Virtualization Enclave, Google Confidential VM, and other types of TEEs. Unfortunately, cloud vendors tend to provide infrastructural support. Customers are responsible for making their programs compatible with the TEE environments. Migrating legacy applications to confidential computing environments is not straightforward and sometimes difficult.

### SUMMARY

In one aspect, a method to generate code and enclave instructions is disclosed. In one embodiment, the method steps include (1) receiving a set of sensitive sources and application code, (2) producing a taint analysis result from performing a forward taint analysis and a backward taint analysis using the set of sensitive sources and the application code, (3) identifying at least one set of computational steps within the application code to be moved to a cloak enclave using the taint analysis results, wherein the cloak enclave is part of a trusted execution environment (TEE), (4) generating enclave instructions by transforming the at least one set of computational steps, (5) replacing each set of computational steps from the at least one set of computational steps with a respective remote function call to a respective one of the enclave instructions, and (6) updating each remote function call in the application code with the respective statement ID linking each remote function call to the respective one of the enclave instructions.

In a second aspect, a method to execute enclave instructions is disclosed. In one embodiment, the method steps include (1) executing application code in a first computing environment, wherein at least one instruction in the application code performs a respective remote function call, where each remote function call utilizes a universally unique identifier (uuid) to a linked set of enclave instructions, and (2) performing a secure computation utilizing the linked set of enclave instructions, wherein the enclave instructions are executing within a second computing environment, the second computing environment is a secure environment, the enclave instructions are generated from the application code using a taint analysis to identify sensitive data, and the application code is updated to replace at least one set of computational steps with the respective remote function call.

In a third aspect, a system is disclosed. In one embodiment, the system includes (1) a receiver, configured to receive a set of sensitive sources and application code, (2) a taint analysis processor, configured to perform a forward and a backward intra- or inter-procedural static taint analysis on the application code using the set of sensitive sources, and (3) a compiler, configured to identify at least one set of computational steps within the application code that use or manipulate at least one sensitive source from the set of sensitive sources, using results from the taint analysis processor, replace the at least one set of computational steps with a respective remote function call to a respective linked set of enclave instructions, wherein each of the respective remote function calls and the respective linked set of enclave instructions are linked using a unique statement ID, and each respective linked set of enclave instructions is generated from a different one of computational steps from the at least one set computational steps.

In a fourth aspect, a non-transitory computer program product having a series of operating instructions stored on a non-transitory computer-readable medium that directs a data processing apparatus when executed thereby to perform operations. In one embodiment, the operations include (1) receiving a set of sensitive sources and application code, (2) producing a taint analysis result from performing a forward taint analysis and a backward taint analysis using the set of sensitive sources and the application code, (3) identifying at least one set of computational steps within the application code to be moved to a cloak enclave using the taint analysis results, wherein the cloak enclave is part of a trusted execution environment (TEE), (4) generating enclave instructions by transforming the at least one set of computational steps, (5) replacing each set of computational steps in the at least one set of computational steps with a respective remote function call to a respective one of the enclave instructions, and (6) updating each respective remote function call in the application code with the respective statement ID linking each remote function call to the respective one of the enclave instructions.

### BRIEF DESCRIPTION

Reference is now made to the following descriptions taken in conjunction with the accompanying drawings, in which:

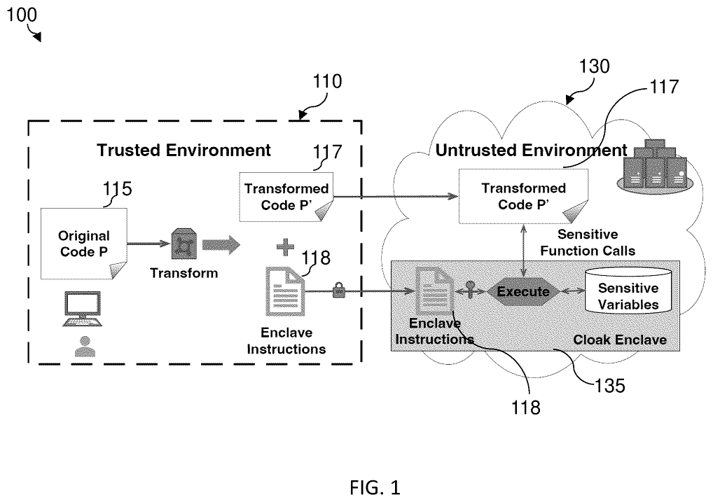

FIG. 1 is an illustration of a diagram of example architecture;

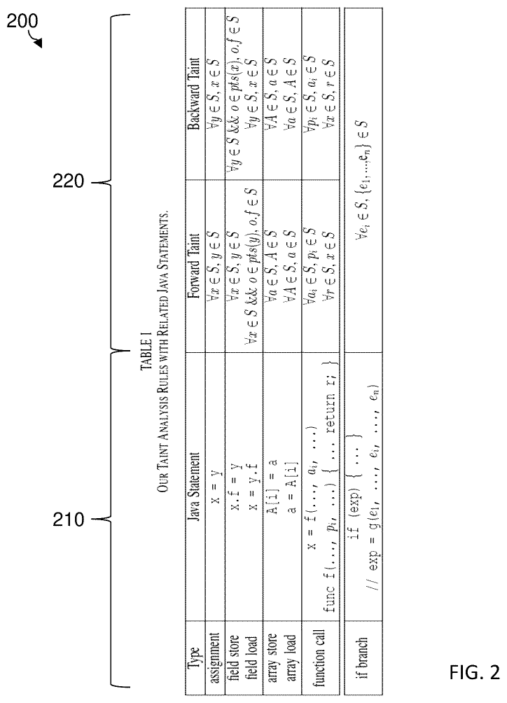

FIG. 2 is an illustration of a table of example taint analysis rule for JAVA statements;

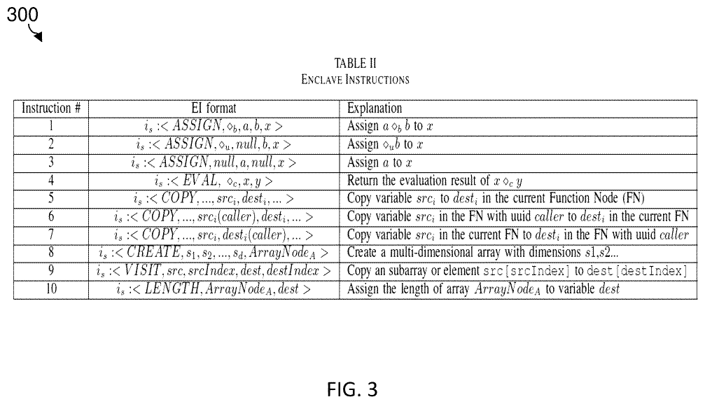

FIG. 3 is an illustration of a table of an example EI set;

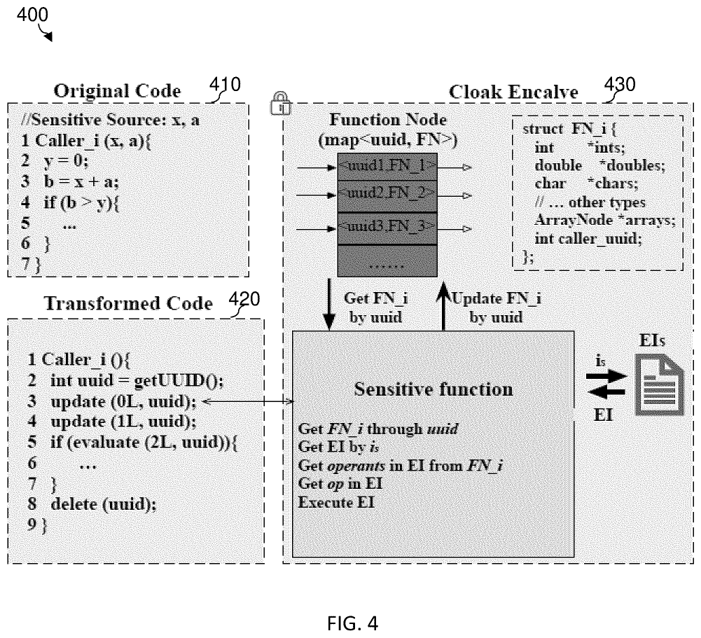

FIG. 4 is an illustration of a block diagram of an example graph demonstrating the storage and computing of sensitive sources in functions;

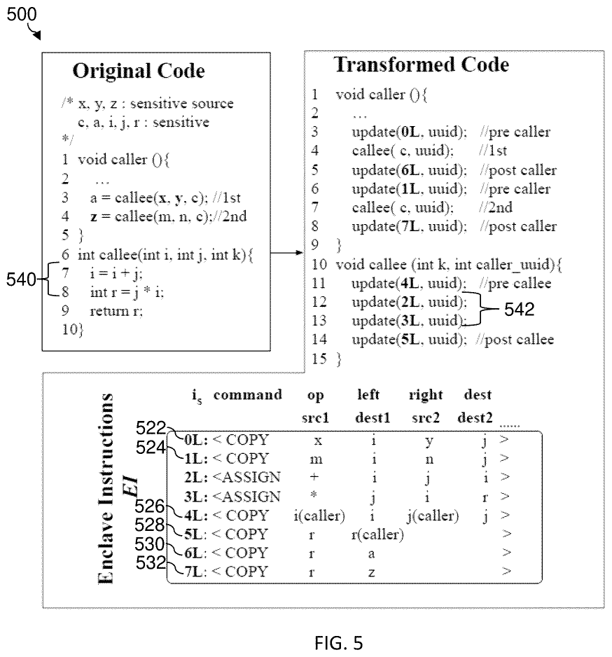

FIG. 5 is an illustration of a diagram of an example of code transformation;

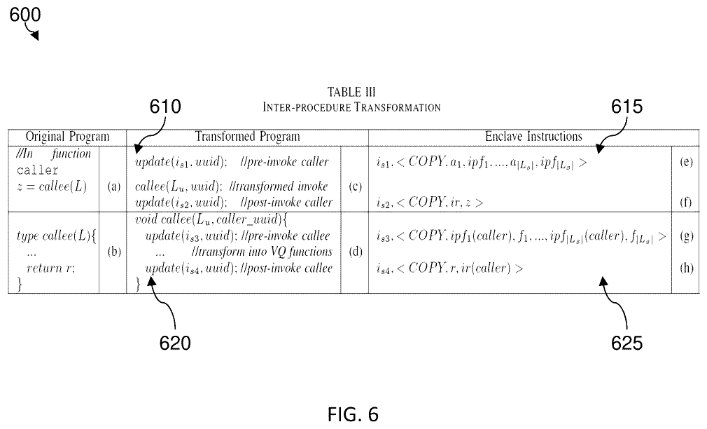

FIG. 6 is an illustration of a diagram of an example table demonstrating an inter-procedure transformation;

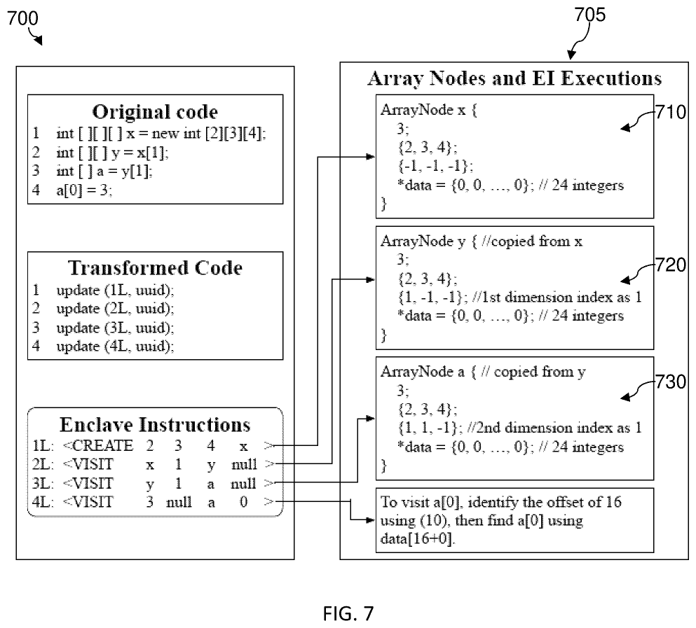

FIG. 7 is an illustration of a diagram of an example array transformation;

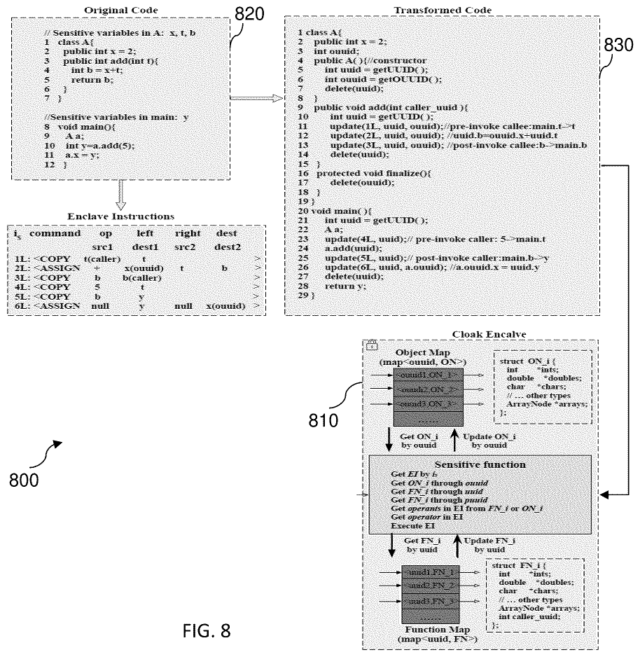

FIG. 8 is an illustration of a diagram of an example object-oriented variable management within the Cloak Enclave;

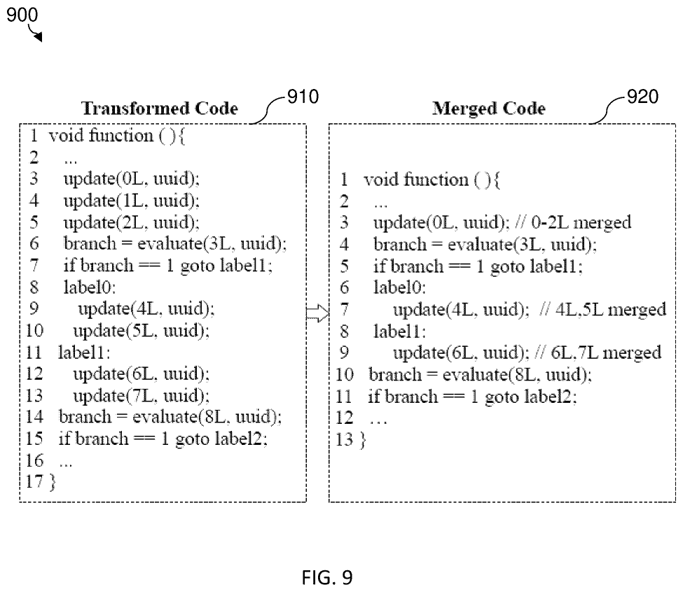

FIG. 9 is an illustration of a diagram of an example for merging transformed code;

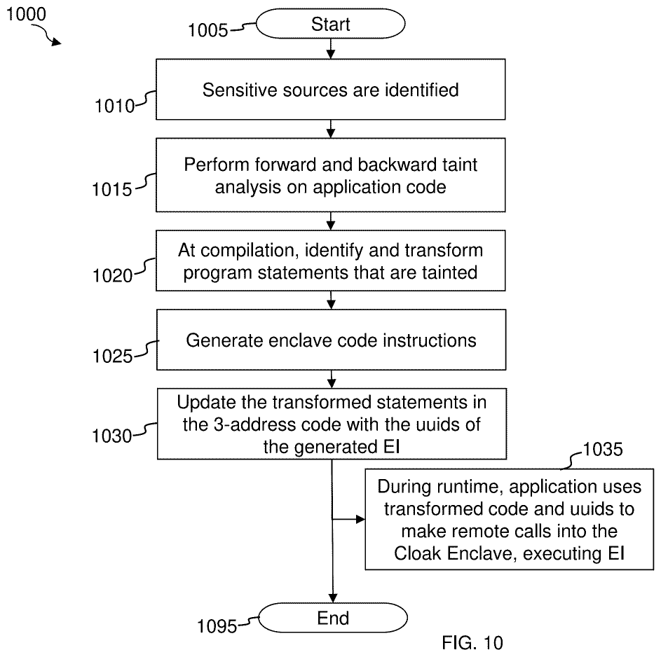

FIG. 10 is an illustration of a flow diagram of an example method;

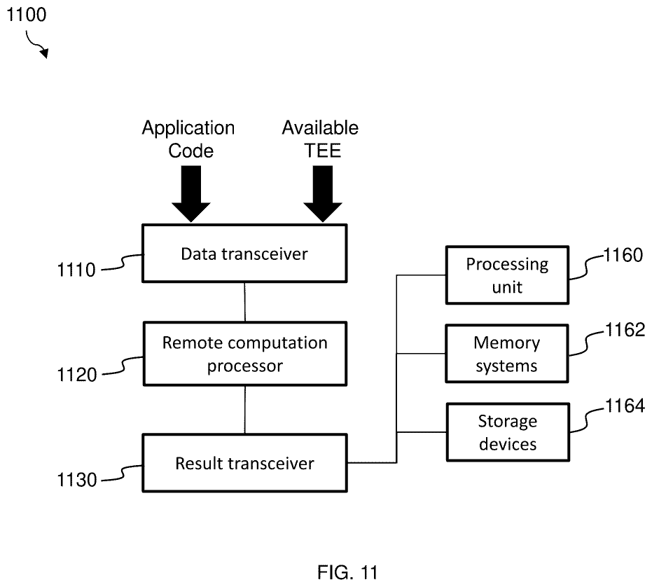

FIG. 11 is an illustration of a block diagram of an example remote computation system;

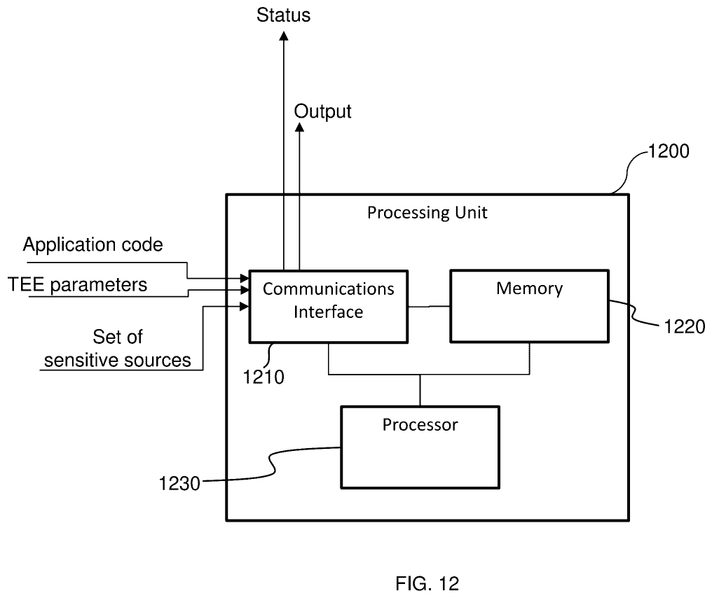

FIG. 12 is an illustration of a block diagram of an example of a remote computation controller according to the principles of the disclosure; and

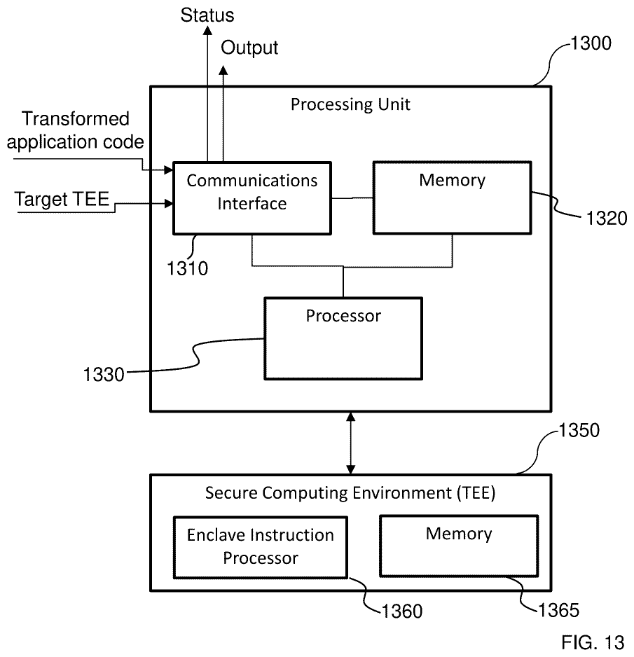

FIG. 13 is an illustration of a block diagram of an example of a remote runtime controller according to the principles of the disclosure.

### DETAILED DESCRIPTION

Offloading computational tasks to an untrusted cloud environment poses significant risks to the security of sensitive data. Trusted execution environments (TEE) allow for the creation of isolated execution environments, where code and data loaded inside can be protected with respect to confidentiality and integrity. The TEE can offer an execution space that provides a higher level of security for trusted applications than management software such as operating systems (OS) or hypervisors.

Intel Software Guard Extensions (SGX) is a TEE implementation available on Intel Xeon CPUs. It creates an isolated execution environment, called an enclave, on the x-86 system, which requires trust in a processor and not in other systems, whether hardware systems, software systems, or systems that are a combination thereof. Application code can be put into an enclave via special instructions and software made available to developers. Enclave code can be called from untrusted code by a call gate-like mechanism that transfers control to a user-defined entry point, namely ECALL, inside the enclave. SGX supports remote attestation, which enables a remote system to verify cryptographically that specific software has been loaded within an enclave and establishes shared secrets allowing it to bootstrap an end-to-end encrypted channel with the enclave. The enclave can provide an execution space that protects sensitive computing against outside access from unauthorized components, including high-privileged subsystems, such as operating systems and hypervisors. Different from VM-level TEE, such as Intel Trusted Domain Extensions (TDX) or AMD secure encrypted virtualization (SEV), Intel SGX provides process-level isolation, which can offer lean protection on sensitive computations.

Many solutions have been proposed to protect programs written in one specific programming language. Haven, SCONE, Graphene-SGX, and SGX-LKL moved OS kernel or C libraries to the enclave so that C/C++ programs can be executed in SGX enclave. Civet and Uranus moved or developed JVM, Java libraries, JIT compiler, or Garbage Collection to the SGX enclave to support Java program execution. RUST-SGX, Python-SGX, Go-TEE, ScriptShield supported the executions of Rust, Python, Golang, and scripting languages (e.g., Lua, JavaScript, and Squirrel), respectively, in the enclave.

The above works achieved the goal by porting language-specific library, interpreter, language runtime library, or C library to the SGX enclave. This class of work may have significant development. These solutions are language-specific and target the Intel SGX, therefore they cannot be easily transferred to other languages and TEE technologies (such as AMD SME, ARM TrustZone). From a security perspective, these solutions may have large trusting bases in the enclave, exposing attack surfaces, which can contradict the principle of lean protection of TEE. Some work directly transforms program code so that sensitive variables are moved to an enclave. Glamdring protects the C code by extracting and moving the functions involving sensitive data to the enclave. The execution of the protected functions is executed through native SGX SDK. Glamdring supports C programs and does not appear to support other languages or advanced language features such as object-oriented features.

This disclosure presents processes to analyze the code at the 3-address code stage, an intermediate layer in the compiler that applies to many programming languages. Through analysis, statements involving sensitive variables can be identified. To support multiple languages, a language-neutral Enclave Instructions (EI) set can be used. The identified sensitive statements can be translated to the EI. The disclosed processes can automatically identify statements that are related to sensitive data (e.g., sensitive variables), and move the computation of those statements to a trusted area in the TEE. The identification can be through program analysis on the 3-address code.

To support the execution of identified statements, the disclosed processes can manage sensitive variables in the TEE, translate the identified statements into the proposed EI instruction, and execute those instructions in the TEE. The execution of EI can be implemented using various programming languages, for example, C/C++. During the runtime, the insensitive statements outside of the TEE can interact with the EI inside the TEE to complete the computing tasks. These processes can protect the confidentiality and integrity of sensitive data while maintaining security and extensibility.

The disclosed processes can be utilized in an environment where there is a trusted and untrusted computing environment working together. For example, the process can be applied to websites, online storefronts, online shopping experiences, accessing government resources, military operations, space exploration operations, satellite operations, mobile phone interactions with outside systems, and other combinations of trusted and untrusted computing systems.

There is a performance overhead for implementing a TEE. For example, in performing experimentation using the disclosed processes, in CPU-intensive applications, the overhead can range between 22.1% to 207.1%, and when using big data applications, the overhead can range between 13.5% and 293.4%. These ranges are from conducted experiments and overhead experienced by other implementations can be smaller or greater than those ranges stated here.

A first step to protecting sensitive data can be to tag sensitive sources in the source code of the application. Sensitive sources can be variables or objects that receive or generate sensitive data. Sensitive data can be personally identifiable information, health information, financial information, business information, trade secrets, classified information, top secret information, court documents, sealed court orders, military information, government communications or data, or other types of sensitive information.

After that, the disclosed processes can analyze and transform the code. The disclosed processes can transform the program based on its 3-address code. Specifically, the disclosed processes can perform a taint analysis using the identified sensitive sources to identify variables that are generated from sensitive sources or generating sensitive sources. The disclosed processes can replace each statement s containing sensitive sources with a sensitive function call, which can be executed in the Cloak Enclave portion of the TEE. In some aspects, two types of sensitive function calls can be supported: update and evaluate, as shown in Pseudo Code 1.

PseudoCode 1: Example function calls supporting an update function and
an evaluate function

| | |
|---|---|
| 1: | update (iₛ, uuid, ouuid=null) |
| 2: | evaluate (iₛ, uuid, ouuid=null) |

In PseudoCode 1, iₛ is an identifier of statement (e.g., statement ID) s. uuid uniquely identifies a function execution of the transformed program (i.e., universally unique identifier (uuid)). It can be used to locate sensitive variables managed in the Cloak Enclave. For the same function that is executed more than one time, each execution can have a different uuid. ouuid can be used to locate sensitive variables of different objects managed in the Cloak Enclave. This parameter can be optional. For example, for the statements that do not involve objects, ouuid can be skipped. The behavior of each sensitive function call can be defined in an instruction of the enclave (e.g., the EI set), which can be parsed and executed in the Cloak Enclave. For example, the format of an EI can use iₛ:<command, . . . >. Example commands are listed in FIG. 3.

To identify sensitive variables, the disclosed processes have a user tag sensitive sources in the original program code P. Sensitive sources can be variables or objects receiving or generating sensitive information. Examples of sensitive sources can be function parameters, received sensitive information, or returns of sensitive information, I/O function calls storing or reading sensitive data to or from a data storage or a network source, or a programming statement using a sensitive source or a variable tainted by a sensitive source. Using the sensitive sources, the disclosed processes can identify the variables that are directly or indirectly related to sensitive sources through a taint analysis.

In some aspects, an intra-procedural and inter-procedural static forward and backward taint analysis can be used to identify sensitive sources and sinks through two steps: (1) forward taint analysis for identifying variables generated from sensitive sources, and (2) backward taint analysis for identifying variables generating sensitive sources. The forward and backward analyses can be used to ensure data confidentiality and integrity because the tainted variables either determine or originate from the values of sensitive sources. Rather than using program dependence graphs, this disclosure conducts taint propagation. An example of taint propagation using seven types of Java statements is shown in FIG. 2.

During the taint analysis, a set S is maintained to record the identified sensitive sources. For example, when an assignment statement x=y is encountered, y can be marked as sensitive by adding y to S if x has already been marked sensitive (e.g., using forward tainting). Continuing the example, x can be marked as sensitive if y was previously marked sensitive (e.g., using backward tainting). A similar taint rule can be applied on field store statements when running forward tainting and on field load statements when running backward tainting. Differently, for a field store, if y is marked sensitive, backward tainting can add o.f to S where o is an object from the points-to set of x (denoted pts(x)). Forward tainting can add o.f to S for field load statements. Array load and store can follow similar rules as assignments. In some aspects, index accesses among an array are not distinguished due to time complexity requirements.

The dataflow for parameter passing values and returning values from function calls can be considered. For example, for forward tainting, a formal parameter can be marked as sensitive if its corresponding actual parameter is sensitive and can mark the assigned variable sensitive if the return value is sensitive. For backward tainting, the actual parameter or return value can be marked sensitive if their corresponding formal parameter or assigned value is sensitive. In some aspects, the predicate of if statements can be considered, where g represents the function or operation that combines the variables e₁ to eₙ to form the predicate exp, as these branches can determine dataflow. In some aspects, other complex statements, such as for and while loops can be converted into if branches for purposes of transforming them to EI.

During the taint analysis, if a statement invokes a third-party function, whose parameters or return values are tainted, i.e., either the actual parameter or the returned variable are in set S, the security of sensitive information could be breached in that function. For example, this can include data I/O, network communication, or third-party data processing functions. In these aspects, warnings can be communicated to the user by alerting them to such a potential threat. The user can decide what to do next. There can be at least three options for the user to choose from. The user can (1) verify that the function will not breach security by reviewing its implementation and decides to proceed, (2) seek a secure implementation of the third-party function, e.g., an encrypted version of that function, which can process sensitive data in a cipher text, or a TEE-based solution that moves the library to a trusted environment, or (3) abort the transformation in order to protect sensitive information.

After the forward and backward taint analysis, statements containing sensitive information can be identified. Each identified statement can be transformed into a sensitive function call statement. The transformation can utilize the 3-address code of the original application. For example, an assignment statement S can be represented as one of these formats: x=a ^{⋄}_{b} b; x=^{⋄}ᵤ b; or x=a, where ^{⋄}_{b} and ^{⋄}ᵤ are a binary and a unary operator, respectively. These statements can be replaced with an invocation instruction, for example, update (iₛ, uuid). In the Cloak Enclave, the assignment statement can be represented as an EI statement, for example, iₛ:<ASSIGN, op, left, right, dest>. ASSIGN can be the command notifying the system that this is an assignment statement, iₛ is the unique identifier of the transformed statement, left, right, and dest indicate the location of the three operands managed in the Cloak Enclave, and op indicates the operation in the RHS of the assignment.

Similarly, a branch statement can be represented in a 3-address code, for example, as if (x ^{⋄}_{c} y) then goto L, where x ^{⋄}_{c} y is the conditional expression and ^{⋄}_{c} is a comparison operator. The transformed branch statement can be expressed as if (evaluate (iₛ, uuid) then goto L.

Turning now to the figures, FIG. 1 is an illustration of a diagram of example architecture 100 for the disclosed processes. Architecture 100 demonstrates two phases of operation, (1) an offline phase, performed in a trusted environment 110, for example, the user's trusted local environment, and (2) an online phase, performed in an untrusted environment 130, for example, a public cloud environment. Trusted environment 110 can be where the application code is analyzed and modified with remote function calls to a set of linked enclave instructions. The enclave instructions can replicate the computational steps that use or manipulate sensitive sources. Untrusted environment 130 can execute the application code in an unsecure environment, while the enclave instructions are executed in a secure environment. This can protect the sensitive sources from being exposed.

Trusted environment 110 can be assumed to be secure, in which the user can safely transform an original code P 115 into a transformed code P′ 117 and a set of Els 118. Information about original code P 115 and Els 118 can be kept secure and not leaked or tampered. After transformation, transformed code P′ 117 and Els 118 can be transferred to untrusted environment 130. Els 118 can be assumed to be securely transferred to the TEE, specifically to a Cloak Enclave 135 portion of the TEE, so that no information is leaked or tampered with. In untrusted environment 130, where the application is about to be executed, the TEE can be assumed to be supported and can properly protect the security of the computation in its enclave.

The code executed inside Cloak Enclave 135 portion of the TEE is assumed to be properly protected with TEE features, such as isolated execution and remote attestation. Any party outside Cloak Enclave 135 cannot eavesdrop on or tamper with data within Cloak Enclave 135. It is assumed that attackers could gain control of the TEE or other portions of the remote environment outside of Cloak Enclave 135 portion, including transformed code P′ 117. The attackers can attempt to perform various static and dynamic analyses in the untrusted area to reveal sensitive information.

FIG. 2 is an illustration of a table of example taint analysis rule 200 for JAVA statements. In taint analysis 200, first two columns 210 show the type and example of statements, and last two columns 220 show taint rules for forward and backward tainting. These statements have been frequently seen in CPU-intensive applications, where the first six types indicate explicit and implicit dataflow in Java programs.

FIG. 3 is an illustration of a table of an example EI set 300. EI set 300 shows a sample of possible EI instructions and their respective meaning. These instructions can be used when executing the code to the Cloak Enclave environment.

FIG. 4 is an illustration of a block diagram of an example graph 400 demonstrating the storage and computing of sensitive sources in functions. Graph 400 has a section for original code 410, a section to demonstrate a sample transformed code 420, and a cloak enclave 430 section.

To ensure that the same variable in different function executions does not conflict, Cloak Enclave can manage sensitive variables used in each function execution in a structure called Function Node (FN). A function can contain multiple types of sensitive variables. The same type of sensitive variables can be stored in an array of that type, referenced by a pointer, as shown in the structure of FNᵢ. The size of each array and whether an array of a certain type can be included in an FN can be determined statically during the program transformation phase, which minimizes the space of each FN. The field caller uuids in each FN record the uuid of its caller function to support intra-procedural or inter-procedure transformation.

To distinguish different function executions, the disclosed processes can generate a statement ID (i.e., uuid) for each function execution by inserting a getUUID function call at the beginning of each function. Cloak Enclave can manage the FNs with a map indexed by the uuid. An FN_i can be located using uuid_i as the search key. Each sensitive function can be executed on the Cloak Enclave. The associated FN with the parameter uuid can be identified, in which its sensitive variables will be located. When a function returns, the sensitive variables in the current function execution are no longer needed, and thus can be removed. In some aspects, a delete (uuid) function call to delete the FN associated with the uuid at the end of each function can be used.

FIG. 5 is an illustration of a diagram of an example of code transformation 500. In the first invocation of callee, the pre-invoke caller instruction (in line 0L 522) assigns variable x and y to intermediate parameters in caller, i and j, respectively. The pre-invoke callee instruction (in line 4L 526) assigns variable i and j in caller to i and j in callee, respectively. When invoking the second callee for the original program (at line 4), the pre-invoke caller instruction in line 1L 524 matches the EI in 4L 526. As a result, in the 1st callee invocation, x in caller is assigned to i; in the 2nd callee invocation, m in caller is assigned to i. When the return value of callee is sensitive, the post-invoke callee update and the post-invoke caller update complete the protected variable assignment from the callee's FN to the caller's FN.

Similar as the pre-invoke update solution, if the return value of callee is sensitive, an intermediate variable in the FN of caller can be used to store the return variable of callee, marked as ir. In this case, the return statement in the callee can be replaced with a post-invoke callee update statement, which copies the returned value to the ir (which can be found through the uuid of caller). In the caller, a post-invoke caller update statement is inserted after the callee invocation to copy ir to z. The post-invoke callee EI (in line 5L 528) assigns variable r in callee to a in caller. The post-invoke caller EI (in line 7L 532) assigns variable r in callee to z. In this example, the EI in line 5L matches EI in line 6L 530 to copy r in the first callee invocation to a.

Inside each function, statements involving sensitive variables can be transformed by following an intra-procedural or inter-procedure transformation design. For example, since i, j, and r are sensitive and maintained in the Cloak Enclave, line 7 and 8 (an indicator 540) in the original program are transformed into update function calls (in line 12 and 13 (an indicator 542) of the transformed program).

FIG. 6 is an illustration of a diagram of an example table 600 demonstrating an inter-procedure transformation. To protect sensitive variables, statements shown in box (a) 610 can be transformed into the three statements shown in box (c) 615 and the transforms of the implementation of function callee shown in box (b) 620 can be transformed into the statements shown in box (d) 625. For the statements in box (c) 615, the uuids refer to the uuid of caller execution; for statements in box (d) 625, the uuids refer to the uuid of callee execution.

In box (d) 625, the parameters of function callee have two parts: Lᵤ and caller_uuid, where Lᵤ=L−Ls, containing insensitive parameters. caller_uuid is the unique identifier of the caller function, which allows the callee function to locate the FN of the caller function. At the beginning of callee, a pre-invoke callee update is inserted, which copies the sensitive variables from the actual parameters in caller to the formal parameters in callee. The sensitive parameters in caller are marked as Aₛ={a₁, . . . a_{|Ls|}} and the sensitive formal parameters in callee as Fₛ={f₁, . . . , f_{|Ls|}.}

Since the callee function could be called from different invoke statements using different variables as actual parameters, in the EI of the pre-invoke callee, it is infeasible to statically specify the source variables. For example, in the original code, the actual parameters for i in callee could be x or m, depending on different invocations. To address this difficulty, intermediate parameters in the FN of the caller can be used to store the actual parameter values during the invocation. Those variables can be marked as Iₛ={ipf₁, . . . , ipf_{|Ls|}}. In caller, a pre-invoke caller update can be inserted before the invoke statement which copies elements in Aₛ to Iₛ.

In some aspects, a COPY command can be used, such as iₛ:<COPY, src₁, dest₁, . . . , srcₙ, destₙ> which can copy variables in the enclave from srcᵢ to destᵢ, where i∈[1, n]. The EI of the pre-invoke caller update copies variables in the actual parameters to the intermediate parameters. The pre-invoke callee update copies variables in the intermediate parameters to the formal parameters. By doing so, the sensitive parameters can be copied from the caller's FN to the callee's FN. By default, the variable can be found in the FN of the current uuid. Therefore, in those EIs, a uuid does not need to be specified. For some variables that are managed in other FNs, the EI can specify the uuid that leads to the FN containing those variables. The source variables belong to the caller's uuid, which can be specified.

FIG. 7 is an illustration of a diagram of an example array transformation 700. For each sensitive array, a structure can be maintained, for example, an Array Node 705, in the Cloak Enclave. Array Node 705 can support one-dimensional arrays, multi-dimensional arrays, and child arrays which are elements of other multi-dimensional arrays.

In array transformation 700, array y 720 is a child array of array x 710, and array a 730 is a child array of array y 720. The structure of Array Node 705 is defined in Pseudo Code 2. In an example of an array node structure, the fields d and dimSize[d] record the number of dimensions and the size of each dimension, respectively. The field index indicates the position of the child array in the parent array. For a d-dimension parent array A, suppose one of its k-d dimensional child array C can be located with A[a₁] . . . [aₖ], the index field of the child array C will be {a₁, . . . , aₖ}, followed by d-k numbers of −1. The actual data of the parent array is stored in the field of data.

| Pseudo Code 2: Example Array Node structure | |
|---|---|
| Struct ArrayNode { | |
| int | d; //number of dimensions |
| int | dimSize[d]; // size of each dimension |
| int | index[d]; // indexes in parent array |
| int | *data; // data in the parent array |
| } | |

For example, array x 710 is a three-dimensional array (recorded in the field d) with sizes of each dimension as 2, 3, and 4, recorded in the field dimSize. Since it does not belong to a parent array, its index field is set to a list of −1. Array y 720 is a child array of array x 710. Array Node of array y 720 is thus generated by duplicating that of array x 710. The difference is the field index. Since array y 720 is the element with index 1 from the first dimension, the index field of array y 720 thus becomes {1, −1, −1}. Similarly, array a 730 is the second element in array y 720, its Array Node is thus copied from that of array y 720 and its index is set as {1, 1, −1}. The structure of Array Node 705 supports element visiting and array length query. For Array Node 705 defined in Pseudo Code 2, suppose the index field has k leading elements that are not −1, meaning it is an element in the d-kth dimension of the parent array, the starting index of that array from its parent's data field will be

$$offset ( d , dimSize , index ) = {\sum }_{i = 0}^{k - 1} ( index [ i ] * {\prod }_{j = i + 1}^{d - 1} dimSize [ j ] ) .$$

The length of the Array Node would be

$$Length ( d , dimSize , index ) = {\prod }_{i = k}^{d - 1} dimSize [ i ] .$$

Since the children arrays share the same values of d, dimSize, and data as their parent array, the Array Node of each child array maintains its own index field and can look up other fields from the Array Node of its parent. In some aspects, to support operations of arrays in EI, there can be three commands, (1) CREATE: used to create a d-dimensional parent array A with sizes of dimensions as s₁, s₂, . . . , s_{d}. It can create an Array Node referenced by the *arrays of the current FN. (2) VISIT: used to copy an array or its element to another array or its element. (3) Length: used to assign the length of array ArrayNode to variable dest.

FIG. 8 is an illustration of a diagram of an example object-oriented variable management 800 within Cloak Enclave 810. Object-oriented is an important feature for modern programming languages. The disclosed processes can manage sensitive variables in each object in Cloak Enclave 810, while keeping other parts of the object outside of Cloak Enclave 810. The sensitive variables of each object can be identified through the taint analysis algorithm. In the enclave, an Object Node (ON) is maintained for each object. The structure of an object node is similar to the function node.

Sensitive variables in an object i can be managed in structure ON_i. The sensitive variables in an object are managed in the same way as the Function Node. The same types of variables are managed in an array through a pointer. Each object can be assigned a unique identifier (ouuid), through which, an object node can be identified quickly on the Object Map. To assign an ouuid to each object, an ouuid member can be added to each class and insert a statement in its constructor to invoke the getOUUID( ) function. The getOUUID( ) function can be executed inside Cloak Enclave 810, which returns a unique ID associating with the current object and creates an Object Node to store the sensitive variables of this object. In the member function of the transformed class, the ouuid can be added as an additional parameter in the update function call, which tells Cloak Enclave 810 the Object Node containing sensitive member variable, for example, update (iₛ, uuid, ouuid).

In object-oriented variable management 800, line 4 in original code 820 can be transformed into line 12 of transformed code 830. The corresponding EI is shown in label 2L. Cloak Enclave 810 will locate x in the ON through parameter ouuid and will locate t and b in an FN through parameter uuid. By default, operants in EI are in the FN of the current function, except for explicitly marking the source (e.g., x(ouuid) at 2L of the Enclave Instructions). To visit a member of a sensitive object member outside of the class, e.g., in line 11 of the original code, the object member can be transformed into an update function, using the ouuid of that object, such as a.ouuid in line 26 of transformed code 830, as the third parameter. By doing so, Cloak Enclave 810 can be able to locate y through the uuid parameter and locate x through the ouuid parameter (i.e., a.ouuid).

In some aspects, when an object is no longer used, the ON can be deleted to save space in Cloak Enclave 810. To achieve that, the finalize function can be overridden in the class of that object, in which, it calls a delete function to delete the ON when an object is no longer used, for example, line 17 in transformed code 830. This design handles the object alias, which is the assignment between objects. The sensitive variables in an object are located through the ouuid of the object. Referencing the ouuid from the alias can still locate the correct ON. For sensitive static variables in a class, a Class Node (CN) can be created in Cloak Enclave 810. The design is similar to ON. Similarly, cuuid(Class UUID) can be used to adopt the idea of ouuid.

FIG. 9 is an illustration of a diagram of an example for merging transformed code 900. Program transformation can generate many update function calls. Each update call can be expensive in terms of switches between the untrusted area and the Cloak Enclave. To improve the performance, each consecutive list of update statements can be merged into one update function call. For example, for three update calls in line 11 to 13 in transformed code 910, the process merges (shown in a merged code 920) them into one update call, using the first iₛ as the first parameters and attach the uuid and ouuid as its remaining parameters, for example, update(1L, uuid, ouuid). In the Cloak Enclave, there are three EIs that need to be executed sequentially: 1L, 2L, and 3L.

In some aspects, consecutive update statements can be merged. That means the merged update statements need to be executed sequentially, while not being split by other function calls or the program control flow. The updates with label 5L and 6L are not merged because they belong to two branches that might not be executed together.

FIG. 10 is an illustration of a flow diagram of an example method 1000 to manage processing applications containing sensitive data. Method 1000 depicts multiple steps of the disclosed processes. Steps 1010-1030 can be performed in a trusted area of a computing system, and step 1035 can be performed partially in an untrusted area (the transformed application code) of the same or different computing system and partially in a secure environment (the cloak instructions executing in a TEE) of the same or different computing system. In some aspects, step 1035 can be performed on a remote computing system. The trusted area computing system, the untrusted computing system, the TEE computing system, or the remote computing system (whether executing the transformed application code or the EI) can be one or more processors in various combinations (e.g., CPUs, GPUs, SIMDs, or other types of processors), a data center, a cloud environment, a server, a laptop, a mobile device, a smartphone, a PDA, or other computing system.

One or more of the described computing systems can be represented by remote computation system 1100 of FIG. 11 or remote computation controller 1200 of FIG. 12. Its trusted area is capable of compiling the code for a targeted processing unit. The trusted area can also be replaced with a local computation system with similar function. The remote environment is capable of executing transformed code where the environment is uses with a TEE. Method 1000 can be encapsulated in software code or in hardware, for example, an application, code library, code module, dynamic link library, module, function, RAM, ROM module, and other software and hardware implementations. The software can be stored in a file, database, or other computing system storage mechanism. Method 1000 can be partially implemented in software and partially in hardware. Method 1000 can perform the steps for the described processes, for example, performing a forward and backward taint analysis of application code, generating Els, and transforming the application code to enable it to make remote calls to the EI executing within a Cloak Enclave environment.

Method 1000 starts at a step 1005 and proceeds to a step 1010. In step 1010, sensitive sources can be identified. Sensitive sources can be variables that store sensitive data, data objects that include sensitive data, code objects that when instantiated could contain sensitive data, or code portions of the application code that use sensitive sources or could at least potentially generate sensitive sources. In some aspects, sensitive sources can be identified through user input. In some aspects, sensitive sources can be identified using a machine learning process, such as scanning the application code for personally identifiable data, health data, financial data, or other categories of sensitive data.

In a step 1015, a forward and backward taint analysis can be performed. The forward taint analysis can be an intra-procedural or an inter-procedural static forward analysis to identify variables or program code statements generated from or using sensitive sources. The backward taint analysis can be an intra-procedural or an inter-procedural static backward analysis to identify variables or program code statements that generate sensitive sources.

In a step 1020, during compilation of the application code, program statements or program objects that could potentially contain sensitive sources, use sensitive sources, or generate sensitive sources can be identified using the taint analysis result from step 1015. The code statement or statements (e.g., a set of computational steps) in the application code can be transformed into remote function calls capable of calling a function specified by the EI where, at runtime operations, is located in the TEE, specifically in the cloak enclave environment of the TEE.

In a step 1025, the enclave instructions can be generated. Each enclave instruction represents a transformation of an original application code that has been replaced by the remote function call (i.e., the EI represents the set of computational steps replaced from the application code). In some aspects, at runtime of the application code, the execution of enclave instructions can occur within the cloak enclave. Each enclave instruction can have one statement ID such as being used to link the remote function call in the application code. Variables operated in the enclave instruction will be managed in the cloak enclave.

In a step 1030, the application code can be updated with the statement ID from the enclave instructions generated in step 1025. The application code then completes the compilation process. In a step 1035, the compiled application call can be executed during runtime operations. The application code can make the remote function calls into the cloak enclave for the protected sensitive sources using the EI. Method 1000 ends at a step 1095.

FIG. 11 is an illustration of a block diagram of an example remote computation system 1100. Remote computation system 1100 can be implemented in one or more computing systems or one or more processors. In some aspects, remote computation system 1100 can be implemented using a remote computation controller such as remote computation controller 1200 of FIG. 12. Remote computation system 1100 can implement one or more aspects of this disclosure, such as method 1000 steps 1010-1030 of FIG. 10 during a compilation time.

Remote computation system 1100, or a portion thereof, can be implemented as an application, a code library, a dynamic link library, a function, a module, a header file, other software implementation, or combinations thereof. In some aspects, remote computation system 1100 can be implemented in hardware, such as a ROM, a graphics processing unit, or other hardware implementation. In some aspects, remote computation system 1100 can be implemented partially as a software application and partially as a hardware implementation. Remote computation system 1100 is a functional view of the disclosed processes, and an implementation can combine or separate the described functions in one or more software or hardware systems.

Remote computation system 1100 includes a data transceiver 1110, a remote computation processor 1120, and a result transceiver 1130. Data transceiver 1110, remote computation processor 1120, and result transceiver 1130 are communicatively coupled. The output is an updated application code with appropriate uuids to access the generated enclave instructions. The output can be communicated to a data receiver, such as one or more of a processing unit 1160 (one or more combinations of processor units or processing cores), one or more memory systems 1162 (e.g., L1 cache or L2 cache of chips, or memory stacks), or one or more storage devices 1164 (e.g., an SSD, database, application storage system, hard drive, or other storage systems). In some aspects, cloak enclave system can output the analysis and interim results of its algorithms, e.g., the results of the forward and backward taint analysis, or other interim analysis.

In some aspects, the results of remote computation system 1100, such as those communicated to the one or more processing units 1160, one or more storage devices 1164, or one or more memory systems 1162, can be retrieved to be reloaded into the processor system during a runtime operation of the application.

Data transceiver 1110 can receive the input parameters, including the application code, the programming language to target, the TEE system to target, the calling ID for the TEE environment, and a set of sensitive sources within the application code. In some aspects, data transceiver 1110 can be part of remote computation processor 1120.

Result transceiver 1130 can communicate one or more outputs (e.g., the transformed application code or the generated enclave instructions), to one or more data receivers, such as processing unit 1160, one or more memory systems 1162, one or more storage devices 1164, or other related systems, whether located proximate result transceiver 1130 or distant from result transceiver 1130. In some aspects, result transceiver 1130 can communicate the interim analysis, such as the taint analysis, to another system, such as to review the analysis to improve correctness of the analysis.

Data transceiver 1110, remote computation processor 1120, and result transceiver 1130 can be, or can include, conventional interfaces configured for transmitting and receiving data. Data transceiver 1110, remote computation processor 1120, or result transceiver 1130 can be implemented as software components, for example, a virtual processor environment, as hardware, for example, circuits of an integrated circuit, or combinations of software and hardware components and functionality. In some aspects, data transceiver 1110, remote computation processor 1120, or result transceiver 1130 can be combined in various combinations. Remote computation system 1100 describes the functionality of the described processes, and the functionality can be implemented using different hardware and software solutions. The functionality described for these components remains intact regardless of how the functionality is implemented.

Remote computation processor 1120 (e.g., one or more processing units such as processor 1230 of FIG. 12) can implement the analysis and algorithms as described herein utilizing the input parameters, such as performing a forward or backward taint analysis. Remote computation processor 1120 can be one or more of a code executing on a processor, a dedicated hardware component, a multicore processor, a multiprocessor system, or a streaming multiprocessor. Remote computation processor 1120 can be implemented by a CPU, a GPU, or other types of processors. Remote computation processor 1120 can be an application compiler or an application compiler system. Remote computation processor 1120 can be a taint analysis processor.

A memory or data storage system of remote computation processor 1120 (such as a core cache, L1 cache, L2 cache, or other memory systems) can be configured to store the processes and algorithms for directing the operation of remote computation processor 1120. Remote computation processor 1120 can include a processor that is configured to operate according to the analysis operations and algorithms disclosed herein, and an interface to communicate (transmit and receive) data.

FIG. 12 is an illustration of a block diagram of an example of a remote computation controller 1200 according to the principles of the disclosure. Remote computation controller 1200 can be implemented on one computer or multiple computers. The various components of remote computation controller 1200 can communicate via wireless or wired conventional connections. A portion or a whole of remote computation controller 1200 can be located at one or more locations. In some aspects, remote computation controller 1200 can be part of another system (e.g., processor, core, server, or other systems), and can be integrated with one device, such as a part of a processing system or integrated circuit. Remote computation controller 1200 represents a demonstration of the functionality employed for the disclosure, and implementations can use a variety of devices, for example, circuits of a processor, dedicated processors, virtual systems, servers, other computing or processing systems, be in software or hardware, or various combinations thereof.

Remote computation controller 1200 can be configured to perform the various functions disclosed herein including receiving input parameters and generating results from execution of the methods and processes described herein, such as performing a taint analysis on a provided set of sensitive sources, generating transformed application code capable of making remote calls to a set of generated EIs (such as steps 1010-1030 of method 1000). Remote computation controller 1200 includes a communications interface 1210, a memory 1220, and a processor 1230. In some aspects, remote computation controller 1200 can implement the processes to generate enclave instructions using the application code and the set of sensitive sources, and update the application code to appropriately reference the enclave instructions. The updated application code and the enclave instructions can be stored or communicated to another system for later use.

Remote computation controller 1200 includes a communications interface 1210, a memory 1220, and a processor 1230. Communications interface 1210 is configured to transmit and receive data. For example, communications interface 1210 can receive the input parameters.

Communications interface 1210 can transmit the output or interim outputs. In some aspects, communications interface 1210 can transmit a status, such as a success or failure indicator of remote computation controller 1200 regarding receiving the various inputs, transmitting the generated outputs, or producing the results.

In some aspects, processor 1230 can perform the operations as described by remote computation processor 1120. Processor 1230 can be an application compiler or an application compiler system. Communications interface 1210 can communicate via communication systems used in the industry. For example, wireless or wired protocols can be used. Communication interface 1210 is capable of performing the operations as described for data transceiver 1110 and result transceiver 1130 of FIG. 11.

Memory 1220 can be configured to store a series of operating instructions that direct the operation of processor 1230 when initiated, including supporting code representing the algorithms and processes for implementing the remote computation process. Memory 1220 is a non-transitory computer-readable medium. Multiple types of memory can be used for the data storage systems and memory 1220 can be distributed.

Processor 1230 can be one or more processors. Processor 1230 can be a combination of processor types, such as a CPU, a GPU, a single instruction multiple data (SIMD) processor, or other processor types. Processor 1230 can be a virtual process supported by a processing unit. Processor 1230 can be dedicated circuitry within a processor. Processor 1230 can be a code process running on a processor. Processor 1230 can be configured to produce the output, one or more interim outputs, and statuses utilizing the received inputs. Processor 1230 can determine the output using parallel processing.

Processor 1230 can be an integrated circuit. In some aspects, processor 1230, communications interface 1210, memory 1220, or various combinations thereof, can be an integrated circuit. Processor 1230 can be configured to direct the operation of remote computation controller 1200. Processor 1230 includes the logic to communicate with communications interface 1210 and memory 1220, and performs the functions described herein. Processor 1230 is capable of performing or directing the operations as described by remote computation processor 1120 of FIG. 11.

In some aspects, remote computation controller 1200 can implement the processes to execute the application code, which includes executing the enclave instructions within a cloak enclave environment.

FIG. 13 is an illustration of a block diagram of an example of a remote runtime controller 1300 according to the principles of the disclosure for runtime operations. Remote runtime controller 1300 is similar to remote computation controller 1200 and can be implemented on one computer or multiple computers. The various components of remote runtime controller 1300 can communicate via wireless or wired conventional connections. A portion or a whole of remote runtime controller 1300 can be located at one or more locations. In some aspects, remote runtime controller 1300 can be part of another system (e.g., processor, core, server, or other systems), and can be integrated with one device, such as a part of a processing system or integrated circuit. Remote runtime controller 1300 represents a demonstration of the functionality employed for the runtime disclosure (such as step 1035 of method 1000), and implementations can use a variety of devices, for example, circuits of a processor, dedicated processors, virtual systems, servers, other computing or processing systems, be in software or hardware, or various combinations thereof.

Remote runtime controller 1300 can be configured to perform the various functions disclosed herein including receiving input parameters and generating results from execution of the methods and processes described herein, such as executing the transformed application code in an untrusted environment where the transformed application code makes remote calls to a secure environment (cloak enclave), such as a TEE, executing the generated Els. Remote runtime controller 1300 includes a communications interface 1310, a memory 1320, and a processor 1330.

Remote runtime controller 1300 includes a communications interface 1310, a memory 1320, a processor 1330 located in an untrusted computing system. Remote runtime controller 1300 is communicative coupled to a secure computing environment 1350 which includes an enclave instruction processor 1360 and a memory 1365. Communications interface 1310 is configured to transmit and receive data. For example, communications interface 1310 can receive the transformed application code and a target TEE. Communications interface 1310 can transmit the output or interim outputs. In some aspects, communications interface 1310 can transmit a status, such as a success or failure indicator of remote runtime controller 1300 regarding receiving the various inputs, transmitting the generated outputs, or producing the results.

In some aspects, processor 1330 can perform the operations as described by step 1035 of method 1000. Communications interface 1310 can communicate via communication systems used in the industry. For example, wireless or wired protocols can be used. Communication interface 1310 is capable of performing the operations as described for data transceiver 1110 and result transceiver 1130 of FIG. 11, or communications interface 1210 of FIG. 12.

Memory 1320 can be configured to store a series of operating instructions that direct the operation of processor 1330 when initiated, including supporting code representing the algorithms and processes for executing the transformed application code. Memory 1320 is a non-transitory computer-readable medium. Multiple types of memory can be used for the data storage systems and memory 1320 can be distributed.

Processor 1330 can be one or more processors. Processor 1330 can be a combination of processor types, such as a CPU, a GPU, a single instruction multiple data (SIMD) processor, or other processor types. Processor 1330 can be a virtual process supported by a processing unit. Processor 1330 can be dedicated circuitry within a processor. Processor 1330 can be a code process running on a processor. Processor 1330 can be configured to produce the output, one or more interim outputs, and statuses utilizing the received inputs. Processor 1330 can determine the output using parallel processing.

Processor 1330 can be an integrated circuit. In some aspects, processor 1330, communications interface 1310, memory 1320, or various combinations thereof, can be an integrated circuit. Processor 1330 can be configured to direct the operation of remote runtime controller 1300. Processor 1330 includes the logic to communicate with communications interface 1310 and memory 1320, and performs the functions described herein.

In some aspects, enclave instruction processor 1360 can perform the operations as described by step 1035 of method 1000. For example, enclave instruction processor 1360 can perform a secure computation utilizing the linked set of enclave instructions, wherein the enclave instructions are executing within a second computing environment separate from the transformed application code, the second computing environment is a secure environment, the enclave instructions are generated from the application code using a taint analysis to identify sensitive data, and the application code has been updated to replace at least one set of computational steps with the respective remote function call.

Secure computing environment 1350 can communicate via communication systems used in the industry with remote runtime controller 1300. For example, wireless or wired protocols can be used. Memory 1365 can be configured to store a series of operating instructions that direct the operation of enclave instruction processor 1360 when initiated, including supporting code representing the algorithms and processes for executing the enclave instructions. Memory 1365 is a non-transitory computer-readable medium. Multiple types of memory can be used for the data storage systems and memory 1365 can be distributed.

Enclave instruction processor 1360 can be one or more processors. Enclave instruction processor 1360 can be a combination of processor types, such as a CPU, a GPU, a single instruction multiple data (SIMD) processor, or other processor types. Enclave instruction processor 1360 can be a virtual process supported by a processing unit. Enclave instruction processor 1360 can be dedicated circuitry within a processor. Enclave instruction processor 1360 can be a code process running on a processor. Enclave instruction processor 1360 can be configured to produce the output, one or more interim outputs, and statuses utilizing the received inputs. Enclave instruction processor 1360 can determine the output using parallel processing.

Enclave instruction processor 1360 can be an integrated circuit. In some aspects, enclave instruction processor 1360, memory 1365, or various combinations thereof, can be an integrated circuit. Enclave instruction processor 1360 can be configured to direct the operation of secure computing environment 1350. Enclave instruction processor 1360 includes the logic to communicate with remote runtime controller 1300 and memory 1365, and performs the functions described herein.

In some aspects, remote computation system 1100, remote computation controller 1200, or remote runtime controller 1300 can be part of another system that receives the input parameters. For example, in some aspects, remote computation system 1100, remote computation controller 1200, or remote runtime controller 1300 can be part of a machine learning system, an AI generative tool, or can be in a data center, a cloud system, an edge system, a corporate system, or other type of system or location. In some aspects, remote computation system 1100, remote computation controller 1200, or remote runtime controller 1300 can be part of a machine learning system, where remote computation processor 1120 can be part of the machine learning processes. In some aspects, remote computation system 1100, remote computation controller 1200, or remote runtime controller 1300 can implement a non-transitory computer program product having a series of operating instructions stored on a non-transitory computer-readable medium that directs a data processing apparatus, when executed thereby to perform operations, the operations comprising the steps described herein for this disclosure, such as one or more steps of method 1000 of FIG. 10.

The disclosed processes can protect the confidentiality and integrity of variables through backward and forward analysis and instruction sets. (1) Confidentiality: If sensitive sources are correctly identified, the variables generated directly or indirectly from it can be identified through forward taint analysis and managed in Cloak Enclave. Variables derived from sensitive sources can be identified through backward taint analysis and can be managed in Cloak Enclave. Therefore, the variables related to x will not be leaked. The coverage includes primitive variables, arrays, and variables in the objects. Although the components of the application system are outside of Cloak Enclave, sensitive data have never left Cloak Enclave, thus is protected.

(2) Integrity: With a sensitive source variable x, variables generating and deriving from x can be identified through taint analysis. The operations of those variables can be performed in Cloak Enclave. Therefore, the data integrity of sensitive variables can be preserved. (3) Security: The trusting base of EnCloak is the implementation of Cloak Enclave that executes the Els. It is easier to be audited than other solutions that introduce various libraries, interpreters, and runtimes to the enclave. (4) Extensibility: Different from other solutions, the design of EnCloak can be transferred to other languages and TEE environments. To protect programs written in other languages, a user needs to implement the translation from the language code to the EIs. Users of other TEE environments need to compile the Cloak Enclave at the selected TEE environment.

A portion of the above-described apparatus, systems, or methods may be embodied in or performed by various digital data processors or computers, wherein the computers are programmed or store executable programs of sequences of software instructions to perform one or more of the steps of the methods. The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein. The data storage media can be part of or associated with digital data processors or computers.

The digital data processors or computers can be comprised of one or more GPUs, one or more CPUs, one or more other processor types, or a combination thereof. The digital data processors and computers can be located proximate to each other, proximate to a user, in a cloud environment, a data center, or located in a combination thereof. For example, some components can be located proximate to the user, and some components can be located in a cloud environment or data center.

The GPUs can be embodied on one semiconductor substrate, included in a system with one or more other devices such as additional GPUs, a memory, and a CPU. The GPUs may be included on a graphics card that includes one or more memory devices and is configured to interface with the motherboard of a computer. The GPUs may be integrated GPUs (iGPUs) that are co-located with a CPU on one chip. Configured or configured to means, for example, designed, constructed, or programmed, with the necessary logic and/or features for performing a task or tasks.

Portions of disclosed examples or embodiments may relate to computer storage products with a non-transitory computer-readable medium that has program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include but are not limited to: magnetic media such as hard disks, floppy disks, and magnetic tape; optical media such as CD-ROM disks; magneto-optical media such as floppy disks; and hardware devices that are specially configured to store and execute program code, such as ROM and RAM devices. Examples of program code include both machine code, such as produced by a compiler, and files containing higher-level code that may be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Those skilled in the art to which this application relates will appreciate that other and further additions, deletions, substitutions, and modifications may be made to the described embodiments. It is also to be understood that the terminology used herein is to describe particular embodiments only, and is not intended to be limiting, since the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

Various aspects of the disclosure can be claimed, such as the methods, systems, and computer program products disclosed herein. Below are claims that can correspond to the various aspects. Each of the example independent claims can have one or more of the additional features of the below dependent claims in combination.

What is claimed is:

1. A method to generate code and enclave instructions, comprising:
receiving a set of sensitive sources and application code;
producing a taint analysis result from performing a forward taint analysis and a backward taint analysis using the set of sensitive sources and the application code;
identifying at least one set of computational steps within the application code to be moved to a cloak enclave using the taint analysis results, wherein the cloak enclave is part of a trusted execution environment (TEE);
generating enclave instructions by transforming the at least one set of computational steps;
replacing each set of computational steps from the at least one set of computational steps with a respective remote function call to a respective one of the enclave instructions; and
updating each remote function call in the application code with the respective statement ID linking each remote function call to the respective one of the enclave instructions.

2. The method as recited in claim 1, wherein the generating enclave instructions occurs outside of the cloak enclave (in a trusted environment).

3. The method as recited in claim 1, wherein the application code, updated with the remote function calls, is compiled and enabled for runtime operations.

4. The method as recited in claim 1, wherein the set of sensitive sources are identified by a user.

5. The method as recited in claim 1, wherein the enclave instruction is language independent from a language of the application code.

6. The method as recited in claim 1, wherein the taint analysis result identifies variables that are included in the set of sensitive sources or computed using the set of sensitive sources.

7. The method as recited in claim 1, wherein the taint analysis result identifies program code statements that use a sensitive source from the set of sensitive sources or a variable that is tainted by the sensitive source from the set of sensitive sources.

8. The method as recited in claim 1, wherein the forward taint analysis is an intra-procedural or an inter-procedural static forward analysis to identify variables or program code statements generated from or using at least one sensitive source from the set of sensitive sources.

9. The method as recited in claim 1, wherein the backward taint analysis is an intra-procedural or an inter-procedural static backward analysis to identify variables or program code statements that generate at least one sensitive source from the set of sensitive sources.

10. A method to execute enclave instructions, comprising:
executing application code in a first computing environment, wherein at least one instruction in the application code performs a respective remote function call, where each remote function call utilizes a universally unique identifier (uuid) to a linked set of enclave instructions; and
performing a secure computation utilizing the linked set of enclave instructions, wherein the enclave instructions are executing within a second computing environment, the second computing environment is a secure environment, the enclave instructions are generated from the application code using a taint analysis to identify sensitive data, and the application code is updated to replace at least one set of computational steps with the respective remote function call.

11. The method as recited in claim 10, wherein the second computing environment is implemented using a trusted execution environment (TEE).

12. The method as recited in claim 10, wherein the linked set of enclave instructions executes within a cloak enclave.

13. A system, comprising:
a receiver, configured to receive a set of sensitive sources and application code;
a taint analysis processor, configured to perform a forward and a backward intra- or inter-procedural static taint analysis on the application code using the set of sensitive sources; and
a compiler, configured to identify at least one set of computational steps within the application code that use or manipulate at least one sensitive source from the set of sensitive sources, using results from the taint analysis processor, replace the at least one set of computational steps with a respective remote function call to a respective linked set of enclave instructions, wherein each of the respective remote function calls and the respective linked set of enclave instructions are linked using a unique statement ID, and each respective linked set of enclave instructions is generated from a different one of computational steps from the at least one set computational steps.

14. The system as recited in claim 13, further comprising:
a first processor system, configured to execute the application code; and
a second processor system, configured to execute each of the respective linked set of enclave instructions, as called by the respective remote function call, within a cloak enclave.

15. The system as recited in claim 14, wherein the second processor system is a trusted execution environment (TEE).

16. The system as recited in claim 14, wherein the first processor system includes a first set of one or more processors, and the second processor system includes a second set of one or more processors.

17. The system as recited in claim 14, wherein the first processor system includes the second processor system.

18. The system as recited in claim 13, wherein the taint analysis processor is a machine learning system.

19. A non-transitory computer program product having a series of operating instructions stored on a non-transitory computer-readable medium that directs a data processing apparatus when executed thereby to perform operations, the operations comprising:
receiving a set of sensitive sources and application code;
producing a taint analysis result from performing a forward taint analysis and a backward taint analysis using the set of sensitive sources and the application code;
identifying at least one set of computational steps within the application code to be moved to a cloak enclave using the taint analysis results, wherein the cloak enclave is part of a trusted execution environment (TEE);
generating enclave instructions by transforming the at least one set of computational steps;
replacing each set of computational steps in the at least one set of computational steps with a respective remote function call to a respective one of the enclave instructions; and
updating each respective remote function call in the application code with the respective statement ID linking each remote function call to the respective one of the enclave instructions.

20. The non-transitory computer program product as recited in claim 19, further comprising:
executing the enclave instructions in a cloak enclave located in a different processing system to where the application code is executing, and the enclave instructions are called by the respective remote function call linked using a universally unique identification.
